(19) United States
(12) Patent Application Publication
(10) Pub. No.: US 2021/0291951 A1
(43) Pub. Date: Sep. 23, 2021

(54) Joystick with control members

(71) Applicant: Ultraflex S.p.A., Casella (GE) (IT)

(72) Inventor: Marcella Gai, Busalla (GE) (IT)

(21) Appl. No.: 17/203,826

(22) Filed: Mar. 17, 2021

(30) Foreign Application Priority Data
Mar. 19, 2020 (IT) 102020000005896

(51) Int. Cl. B63H 25/02; B63H 20/08; B63H 20/02

(52) U.S. Cl. CPC B63H 25/02; B63H 2025/026; B63H 20/02; B63H 20/08

(57) ABSTRACT

A lever control member, also known as joystick, for generating command signals that control the movement of boats, watercrafts or the like includes a base, a stick, a shaft for supporting the stick, a joint mechanically coupled to the shaft and positioned in a supporting housing included in the base, one or more sensors, one or more electronic circuits, and one or more control mechanisms, for example, one or more buttons. A subset of those control mechanisms possibly may be positioned on the stick and may be used to manage the swaying of one or more outboard motors around a horizontal axis parallel to the transom, known as “trim.” The joystick may be provided with an ergonomically shaped control mechanism and/or a rotating member, which may be activated by an operator.

### FIELD OF THE INVENTION

Object of the invention is a multi-axis articulated lever control member, also known under the name joystick in the family of variants used in the nautical sector, without excluding its use in other fields of application relating to the simplification of manual operations required for the movement control of complex systems.

In particular, reference will be made to the use of said control member or joystick for steering boats, watercraft or the like having an autonomous propulsion system comprising at least one rudder and/or at least one motor for varying the dynamic conditions of one or more propulsion propellers, such as the number of rotations or the direction of rotation of said propellers.

### BACKGROUND OF THE INVENTION

The movement of outboard motors and/or motors equipped with stern leg includes the classic steering rotation, the possible translation in a vertical direction along a vertical axis or in the vertical plane and inclined towards the bow or the stern of the boat and the swaying of the motor or of the stern leg around a horizontal axis and substantially parallel to the transom, so-called “trim” movement. In the case of outboard motors, a commonly adopted implementation provides that this sway occurs relative to a fulcrum point positioned in correspondence of the steering components of the motor.

Motor trimming determines an orientation change of the propellers that modify the direction of the thrust force thereby orienting that force more downwards or upwards, in fact altering the thrust line of the propeller, being one of the main controls that have an effect on the dynamics of the boat in the various driving conditions that said boat encounters when it is in the water.

It is important to note that the inclination of the motor becomes relevant also during the preparation and during the stationary phase when it is necessary to bring the propellers and/or the end part of the motor above the waterline, in fact bringing out of the water all or part of the member of the motor that in operating conditions are submerged. Consequently, depending on the type of boat and when required, by acting on the trim control to raise said motor end part and/or said propellers, it is possible to store on land the boat, which operations would otherwise be hindered by the presence of said parts protruding from the keel which would probably be damaged by contact with the ground.

In this context it is possible to define a normal position of the motor, corresponding to a zero trim angle, in which the hydrodynamic flow generated by the action of the propeller is positioned in a plane parallel to the horizontal plane of the boat and therefore, if the propeller is arranged orthogonally to the axis of the motor, said motor is perpendicular to said horizontal plane of said boat.

As mentioned, the motor inclination just described is one of the main parameters that determine the motion of the boat: negative trim values, equivalent to the propeller coming closer to the transom from its normal position, when combined with speed-increasing action in the forward direction by the propeller, result in a hydrodynamic thrust force that tends to bring the boat's bow down; Alternatively, positive trim values have the effect of raising the bow during acceleration and bringing the stern and consequently the foot of the propeller deeper; various consequences are associated with these movements, including for example an improved or worsened boat manoeuvrability, swaying movements in the longitudinal plane (pitching), increased fuel consumption, propeller cavitation phenomena with relative loss of speed. It becomes therefore evident the need for the pilot to be able to control in a simple, continuous and precise way the trimming of one or more motors in the same way as the other directional parts of the boat have to be controllable. In presence of several motors it is possible to provide embodiments in which the trim control can be performed independently between each motor.

The trim implementation is not an object of the invention, but different types of devices are known to assist the sway of the motor or of the stern leg around an horizontal axis substantially parallel to the transom; the actuator and therefore also the power signal and the means of generation of the same can be of mechanical, electro-mechanical, hydraulic, electro-hydraulic, electrical, magnetic, or of any other type available in the state of the art suitable to perform trim movements of one or more motors. According to the embodiments, one or more actuators may be provided, as well as at least one motor and/or propeller without prejudicing the application context of the invention.

On the other hand, with regard to the control members for the movement of the motors or for the translation and/or rotation in boats, vessels or similar known to the state of the art, they are generally constituted by a steering wheel or rudder wheel or by a bar that regulates the orientation of the motors and/or rudders, while the control members of acceleration and deceleration are generally constituted by a hub assembly with lever to control the speed, direction and neutral position or the non-rotation position of the propeller. All or part of the functions of these members can be carried out by one or more lever elements or joysticks, which can advantageously simplify the control operations of the boat and allow the simultaneously control of several movement actuators, being articulated on several axes and being able to generate command signals depending on the operators' actuation.

From the foregoing, it becomes evident that the trim function of the propulsion units is a fundamental operation both in the operations of conducting the vessel in open sea, and in the operations of docking and landing. Given the need to enable the use of the trim contextually to the control functions of the traditionally known propulsion and steering members, i.e. rudder orientation and speed/rotation direction of the propellers or equivalent thrust systems, the applicant felt the need to integrate said trim functions into the state-of-the-art lever control systems, in fact extending the capabilities of the joystick and thus making possible the complete control of the motors by the operator that through a single control member can autonomously govern the boat in the various situations presented above, even with only one hand both right and left.

Moreover, again in order to facilitate the full control by the boat, the joystick object of the invention may be provided with one or more additional control members having an ergonomic shape specifically designed to allow its use in combination with the control functions known at the state of the art, without interfering with said functions and extending the control capabilities of the joystick itself, providing for the possibility of including active mechanisms such as, for example, tactile feedbacks allowing a bidirectional interaction between the control member and the operator during use.

In general, the joystick is made of a shape and size such that it can be used manually by a single operator who has the possibility of holding a movable main body, hereinafter referred to as the stick, constrained at one end terminating on a fixed body, hereinafter referred to as the base. Said joystick can therefore offer various degrees of freedom both in terms of stick swaying around the constrained end and in terms of additional devices that can be placed generally on any surface of the member.

### SUMMARY OF THE INVENTION

The Invention as Claimed Comprises Therefore a Multi-Axis Articulated Lever Control Member, Also Known Under the Name Joystick, for Generating Command Signals Aimed to Control the Movement of Boats, Watercraft or the Like by One or More Operators Comprising:

a base,

a stick,

at least one shaft for supporting said stick,

a cardan joint or similar member mechanically coupled to said shaft and contained in an appropriate supporting housing,

one or more status sensors,

one or more electronic circuits possibly mechanically anchored to the base and which possibly comprise one or more microprocessors,

comprising one or more control mechanisms, such as for example one or more buttons, a subset of said buttons possibly being positioned on the stick and/or on the base of said lever control member,

and said control buttons being usable by the operator for managing the swaying of at least one or more outboard motors, i.e. of the end part of one or more inboard/outboard motors around a horizontal axis substantially parallel to the transom, a swaying movement also known under the term “trimming.”

The shaping of the surfaces and of said devices, as well as the characteristics of the allowed movements is such as to maximize the effectiveness of the actions while facilitating their use. To this purpose, a preferred embodiment provides that the stick is supported by at least one cylindrical mechanical element hereinafter referred to as shaft and a cardan joint or similar member mechanically coupled to said shaft and contained in a appropriate supporting housing; in addition to the ability to move the stick and therefore the shaft there are also provided one or more control mechanisms that can be activated by the operator, such as for example one or more buttons or selectors that, as said, can be positioned on any part of the surface of the stick and/or base; said mechanisms being activated together with or independently from the positioning of the stick and it is provided that a subset can be dedicated to the managing of the inclination of at least one or more outboard motors or of the end part of one or more inboard/outboard motors around a horizontal axis, substantially parallel to the transom, or to the trimming of the motors. The trimming control operations that the operator performs by means of the aforesaid devices are detected by appropriate status sensors and processed by dedicated electronic circuitry able of transducing the actions performed by the pilot into electrical signals that can be processed by the circuitry provided by the invention, possibly comprising shared or dedicated microprocessors, and at least partially housed inside the stick and/or inside the base of the joystick.

Advantageously, preferred embodiments comprise functionalities such that the resting position of the stick when not stimulated by the operator is maintained in the initial position, e.g., parallel to the axis normal to the plane of said base, also by means of mechanical members having appropriate elastic characteristics such as to maintain the shaft in a predetermined position without preventing movement of the stick in the various degrees of freedom; optionally a spring disposed axially to the stick support shaft, said spring being restrained by supports and/or seats between the upper surface of the base and the lower surface of the stick.

In yet another embodiment, the joystick control capabilities provided by the aforesaid control mechanisms are extended by detecting the position of the stick relative to the base by means of appropriate sensors designed to determine the change of state of the cardan joint as a result of at least one or more movements of the stick resulting in an angular change in the plane XY defined by the normal that coincides with the axis of the cylinder forming the joystick shaft. Even this embodiment involves a section of electronic circuitry and possibly microprocessors, partially housed inside the stick and/or the base of the joystick and designed to process the signals coming from said sensors for generating command signals.

In yet another executive form, the control mechanisms included in the joystick, i.e. a subset of said control devices, are realized as an alternative to the buttons described above: for example, bistable switches or multiple selection switches, whether sequential or random, or variable selectors such as the common potentiometers used in the electronic field; the use of these or other particular devices will be considered by the person skilled in the art who will also choose them according to their use in the overall joystick system, and also in this sense this and other embodiments can provide a visual and/or acoustic indication to inform the user of the current state of the control mechanism.

In other embodiments, possibly in combination with one of the above or below listed and/or other embodiments not mentioned herein, the control buttons are also able to provide a variable electrical signal as a function, possibly a linear function, of the action the operator applies to the device itself. With simple mechanical parts such as a spring of known elastic force or with basic electronic components such as potentiometers, it is possible to transform a binary state activation button (on/off) into an analog sensor which can provide the microprocessor with informations necessary to generate control commands such as a variable trim angle depending on the shift applied to the button.

Advantageously, the arrangement of the control mechanisms can be carried out, in particular non-exclusive embodiments, by providing the control mechanisms with specific geometric shapes of both the individual mechanism and the ensemble of mechanisms being composed when positioned in the various shell surfaces of the control member. In the embodiments that include said mechanisms in the form of push-buttons, for example, said mechanisms can be arranged so as to compose sectors of circular crowns arranged along a semi-arc centered with the shaft and prearranged for being used by the operator for setting the various types of controls for managing the movement or parking of the boat.

In yet another embodiment variant, these control mechanisms can be equipped with graphical and/or tactile symbols of various shapes and sizes, adapted to facilitate recognition and selection by the pilot; in other embodiments, the single button can be multifunctional and associated to control electronics that allow its dynamic configuration according to software algorithms that release the action performed by the operator on the button (or buttons) from the command resulting from the circuitry that compose the control device.

Alternatively or in addition to some of the user interaction functions, it is contemplated by the invention that notifications of the actual state of the control member and/or boat can be generated, thus providing optical, acoustic, and/or tactile transduction devices able to interoperate with the user according to their actions and/or the condition of the control member and/or boat. Advantageously, said interaction can be supervised or conditioned by the possible on-board electronics in order to maximize its operating efficiency.

Other embodiments, which can be combined in part or entirely with the features of the invention, provide that the end part of the stick is equipped with an operative unit able to carry out at least one sway, when manually stimulated by the operator, preferably around an axis substantially parallel to the longitudinal axis of said shaft and said sway being able to occur independently of other possible movements that the operator can carry out on the control system such as, for example, the inclination along the X and/or Y axis.

Said operative unit can comprise an outline (91) of ergonomic type that facilitates the use by the operator, for example being able to accommodate the thumb of the right or left hand, while the other fingers grip the main body of the stick. Said terminal operative unit can be provided with at least one or more control mechanisms such as for example buttons or switches or selectors, also equipped with mechanisms for retaining or maintaining the state and eventually with progressive action and electrically coupled to at least one controlling circuitry, with respective functions of light and/or acoustic signal to indicate the state of their activation.

Based on its theoretical and experimental experience in the field of lever control devices, the applicant could see the advantages for the operator in using an additional control member integrally connected to the base of the joystick object of the present invention. Accordingly, the invention has been defined so as to comprise, in embodiments of interest and non-limiting embodiments, a rotating body preferably arranged on a surface integral with the joystick base and preferably in line with the shaft (3) supporting the stick, such as, for example, a ferrule rotatable in a one-way or two-way direction, manually rotatable by the operator by movement in one or more predetermined positions but also, in embodiments not contemplating predetermined positions, in any possible state in a range of positions varying between a maximum and a minimum.

Said maximum and minimum are not limited a priori and can possibly delineate an entire perigon, i.e. a smaller angle or a greater angle whenever desiring to configure said rotating body in multi-turn mode. Other embodiments may comprise a system of one or more status sensors electrically connected to one or more microprocessors for processing the signals generated as a consequence of the static or dynamic conditions following the actuation by the operator and/or one or more light indicators adapted to signal, continuously or temporarily depending on a predefined duration, the status of said rotating body, for example in form of a coaxial secondary ferrule comprising a plurality of LED indicators activating or deactivating depending on the relative or absolute position of the control member.

Although multiple combinations of the characteristics so far described are possible, it is possible to realize the invention in the embodiment in which the main characteristic includes an operative unit in the end part of the stick being able to perform at least one rotation, when manually stimulated by the operator, around the longitudinal axis of said shaft and said rotation can occur independently with respect to other possible movements that the operator can perform on the control system such as, for example, the inclination along the X and/or Y axis of the plane of the base as indicated in the drawing tables.

Advantageously, variants of said embodiment are contemplated in which said operative unit is further provided with a outline of ergonomic shape that facilitates the use by the operator without interfering with other operations performed at the same time by said operator on the same control member, preferably being able to accommodate the thumb of the right or left hand while the other fingers grip the main body of the stick.

Yet, other variants of the previous embodiments are possible, wherein said terminal operative unit is provided with at least one or more control mechanisms such as for example one o more buttons electrically coupled to one o more microprocessors,

one or a subset or the totality of said control buttons being adapted to comprise a device, possibly mechanical, adapted to maintain the activation or deactivation status once set by the operator, without successive mechanical actions for maintaining said status,

said buttons possibly being provided with an electric or mechanical or electromechanical device adapted to determine the progressive pressure exerted by the operator, and with a single and/or common light and/or acoustic signal to indicate the activation status thereof.

Other variants include that said buttons, i.e. more generally said control mechanisms, are positioned on the shell surface of the stick and/or on the rotating head positioned at the end part of the stick so that to allow the activation by the operator with a simple action of the thumb that does not interfere with the other possible actuations of the control member, such as for example the inclination of the stick in the two-dimensional space defined by the horizontal plane of the lever control member.

Further, it is possible to realize the invention in the embodiment in which the main characteristic comprises a rotating body, preferably arranged on a surface integral with the base of said control member and in-line with the shaft supporting the stick,

possibly made in the shape of a ferrule rotatable in one or two directions,

manually positionable by the operator in one or more predefined positions, or in any possible status of the range of variable positions between a maximum and a minimum in the absence of predefined positions,

said maximum and minimum not being limited a priori and possibly being able to delineate an entire perigon, i.e. a smaller angle or a greater angle whenever desiring to configure said rotating body in multi-turn mode.

The above described embodiment can also be equipped with a system of one or more status sensors electrically connected to one or more microprocessors for processing the signals generated as a consequence of the static or dynamic conditions following the actuation by the operator.

In addition, a variant is provided, wherein the rotating selecting body comprises one or more light indicators adapted to signal, continuously or temporarily depending on a predefined duration, the status of said rotating body.

### BRIEF DESCRIPTION OF THE DRAWINGS

The features and advantages of the present invention will become apparent from the following detailed description of some exemplary embodiments, which are not intended to be exhaustive or limitative, and with reference to the accompanying drawings:

FIG. 1 shows an overall view of a possible embodiment of the lever control member also known under the term joystick.

FIG. 2 shows an overall view of a possible implementation of a stick 2 of the lever control member or joystick.

FIG. 3 shows two of many possible implementation variants of the base 1 of the control member.

FIG. 4 shows a top view of the base of the lever control member.

FIG. 5 shows a possible embodiment of the free end part of the stick.

FIG. 6 shows another possible embodiment of the free end part of the stick in a bottom view.

FIG. 7 shows a side view of the free end part of the stick in contact with the user's thumb.

FIG. 8 shows a further possible embodiment of the free end part of the stick with an indication of two possible degrees of movement.

FIG. 9 shows other possible embodiments of the stick.

FIG. 10 shows other possible embodiments of the base of the control member.

FIG. 11 shows an implementation embodiment of a spherical member rotating within a supporting housing.

FIG. 12 shows the elements of the previous figure positioned in a possible Cartesian plane XY and also presenting an embodiment of the shaft supporting the stick.

FIG. 13 shows an assembly of the mechanical and electrical members possibly comprised in the base of the lever member.

FIG. 14 shows an assembly of the mechanical and electrical members possibly comprised in the base of the lever member and connected to an embodiment of the stick, including the free end part.

FIGS. 15, 16, 17 and 18 show views of a possible implementation of the lever member as a whole.

FIG. 19 shows some details shown in the previous figures, in particular with reference to a possible realization of the control buttons on the base with an example of possible graphic symbols associated to said buttons.

FIG. 20 shows some particulars of a possible embodiment in details of the members between the base and the linked part of the stick.

FIG. 21 shows some particulars of a possible embodiment of the base of the lever control member.

FIG. 22 shows some particulars of a possible embodiment of the stick of the lever control member.

FIG. 23 shows an overall view of the embodiment of FIGS. 21 and 22.

### DETAILED DESCRIPTION OF EMBODIMENTS OF THE INVENTION

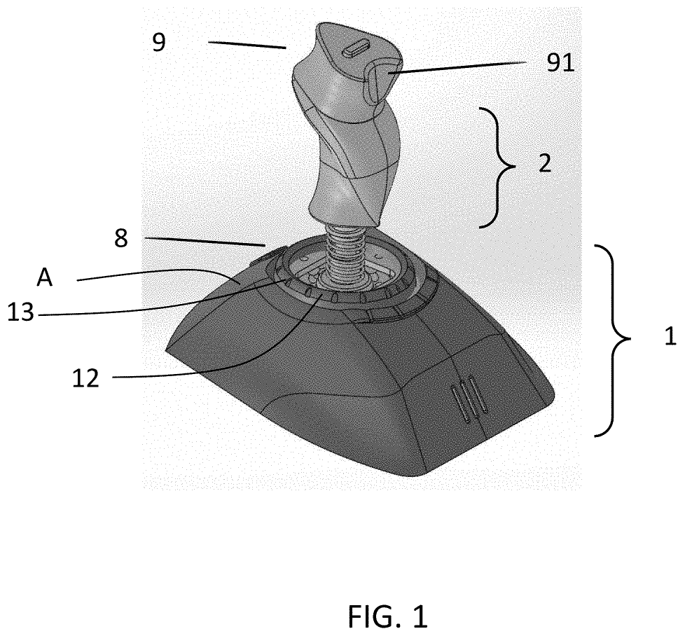

With reference to the above figures, FIG. 1 shows an overall view of a possible embodiment of the lever control member also known under the name of joystick, comprising a series of members among which it can be identified the base 1 which can be mechanically anchored to a horizontal or oblique plane and acting, among other things, as a support for the stick 2, which stick is provided with two or more degrees of freedom manually activated by the operator using the same; the joystick in this example includes, among other things, manually operated control buttons 8 and 8′ which are available to the operator according to the control requirements of the boat, and an operative unit located on top of the shaft 9 able to perform sway movements around an axis substantially parallel to the shaft and provided with a recess 91 ergonomically shaped for accommodating the operator's thumb.

In an embodiment of the invention, said control mechanisms comprise two buttons 8, 8′ disposed on the base 1 or on the stick 2 in the portion of the surface closest to the base 1, which buttons are positioned in the front area A of said member with reference to the grip condition of the stick 2 or in the position most distant from the body of the user gripping the stick 2 with one hand and possibly gripping the base 1 with the other hand. In this way, the buttons can be pushed without moving the hand away from the grip position and the operator can control the boat by moving the lever and simultaneously activate the buttons 8, 8′ with a slight movement of one or two fingers of the hand without reducing the control of the joystick lever. Preferably, the two buttons are used for controlling the trimming position of the thrusters to respectively control the increase or decrease of the angular inclination of the same with respect to the horizontal axis parallel to the transom.

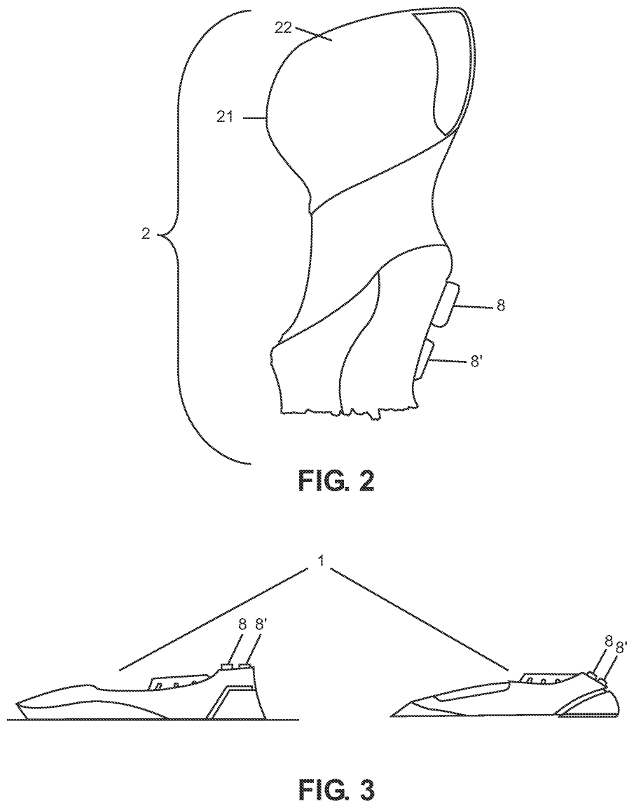

More in detail, FIG. 2 shows an overall view of a possible implementation of a stick 2 of the lever control member or joystick, while FIG. 3 exemplifies two of the many possible implementation variants of the base 1 of the lever control member; with reference to FIG. 2 it can be noticed a possible modeling of the stick for obtaining a particular ergonomy to improve the use by the operator; it is also noticeable the presence of a surface shell adapted for covering the entire lateral profile of the stick 2 and an end part 22 completing the upper part of the stick 2. This figure also shows two devices for controlling the inclination of the trimming i.e. of the thrust system of the boat along the longitudinal plane normal to the transom, said devices being a possible variation of the features characterizing the invention and represented in this and other examples in form of trim buttons 8 and 8′.

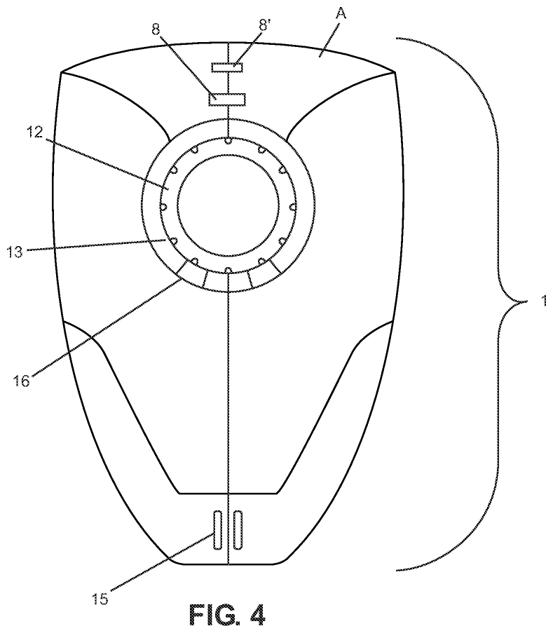

In other possible embodiments, these buttons can be located on the base of the joystick as seen in the two views of FIG. 3 which share some design aspects, such as the support for the stick 2, but differ in other characteristics such as the positioning and orientation of the trim buttons 8, 8′. Continuing with the possible embodiments of the joystick base 1 and with reference to FIG. 4 showing a top view of base 1, an implementation variant is shown in which, in addition to two trim buttons located in the upper part of base 1 other parts are included, such as a rotary selector 12 here represented in the form of a rotating ferrule designed to be manually activated by the operator and to be set in an arbitrary position by the operator, possibly limited between a minimum and a maximum rotation angle, according to the cause-effect relations set by the algorithm acting by means of one or more processing devices possibly included in the joystick.

Also referring to FIG. 4, the rotating body shaped like a ferrule 12 includes a series of light indicators 13 positioned on the surface of said ferrule to provide visual positioning indications to the operator such as, for example, the offset angle with respect to an initial position and/or contextual indication for the movement of the actuating members; the base 1 exemplified in this figure also includes a number of auxiliary control buttons 11 located at the bottom of a crown which is concentric to the rotating ferrule for reasons of implementation and offers further possibilities for generating specific commands for controlling the boat; in the lower part of the base is finally included a system for generating acoustic and/or vocal signals 15, the signals being able to be generated by a transducer positioned inside the base and the base having appropriate slots to allow the propagation of sound towards the operator.

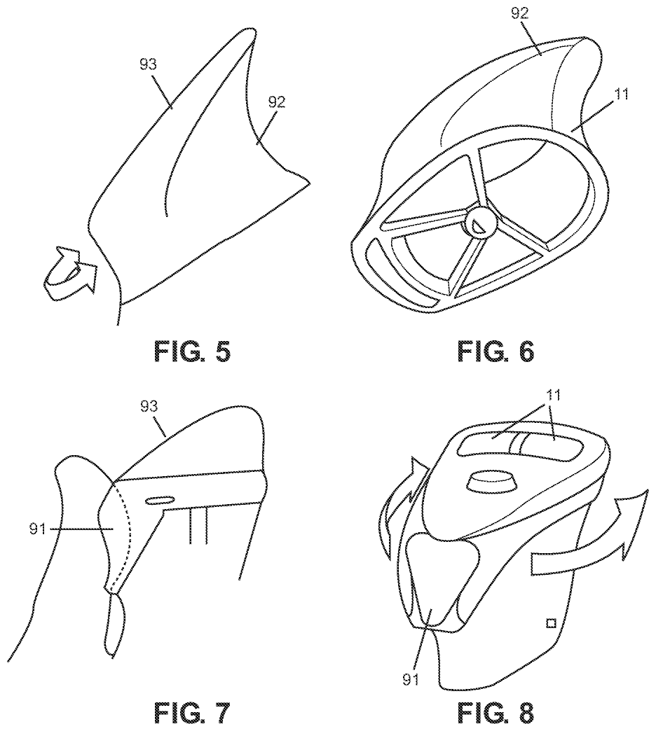

FIG. 5 shows a possible implementation embodiment of the free end part of the stick 2, evidencing the movable head surface 93 and shell surface 92, said surfaces being able to comprise one or more control devices such as, for example, auxiliary control buttons 11 as exemplified in FIG. 6, while the shape of said end part can be modeled in such a way as to make it ergonomic and thus easily activatable by the operator, for example, upon using the thumb (FIG. 7) which fits into the outline 91 of the shell shown in FIG. 8, simplifying any possible rotation actions of the end part.

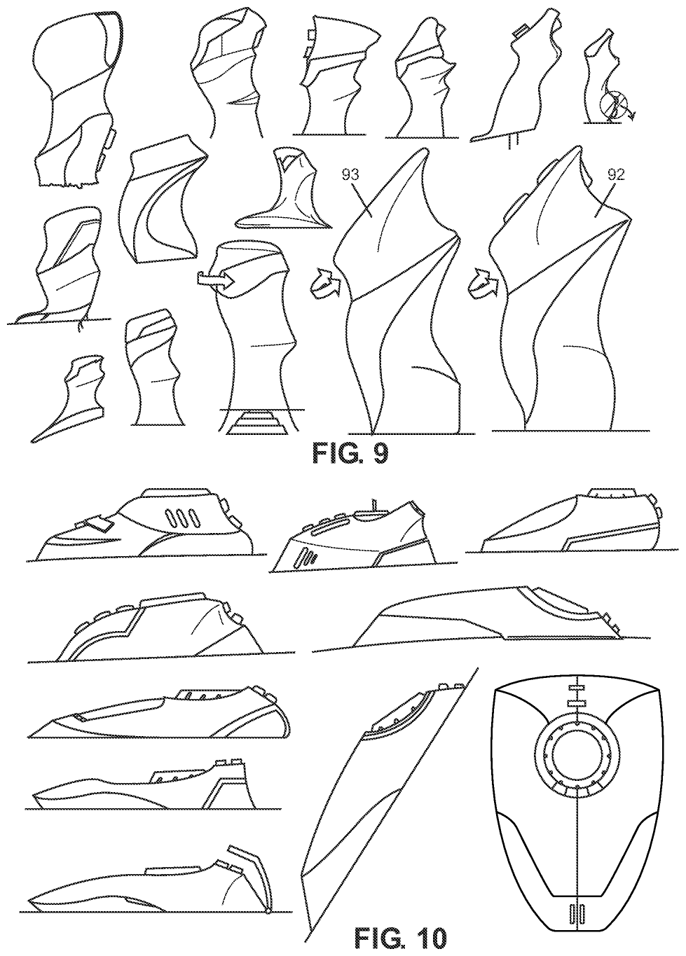

Further embodiments of the control member are shown in FIGS. 9 and 10, in their respective stick (FIG. 9) and base (FIG. 10) references.

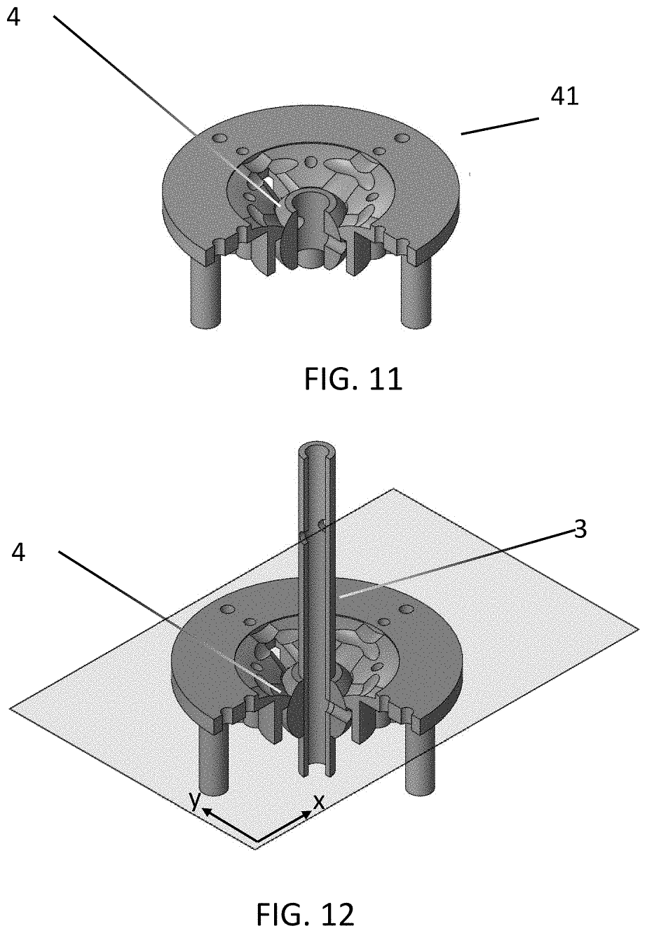

Going into more detail of a possible embodiment, FIG. 11 shows a spherical-shaped member 4 constrained in translation to a supporting housing 41 that prevents linear displacement while leaving it free to rotate within the seat; said spherically shaped member 4 is provided with a cylindrical cavity suitable to accommodate a hollow shaft 3 as shown in FIG. 12; shaft 3 and spherical member 4 are mechanically coupled together and, by virtue of the rotational freedom of said spherical organ within the supporting housing 41, providing the stick 2 with the capacity to sway about the normal of the two-dimensional plane XY in which the supporting housing lies, as shown in FIG. 12.

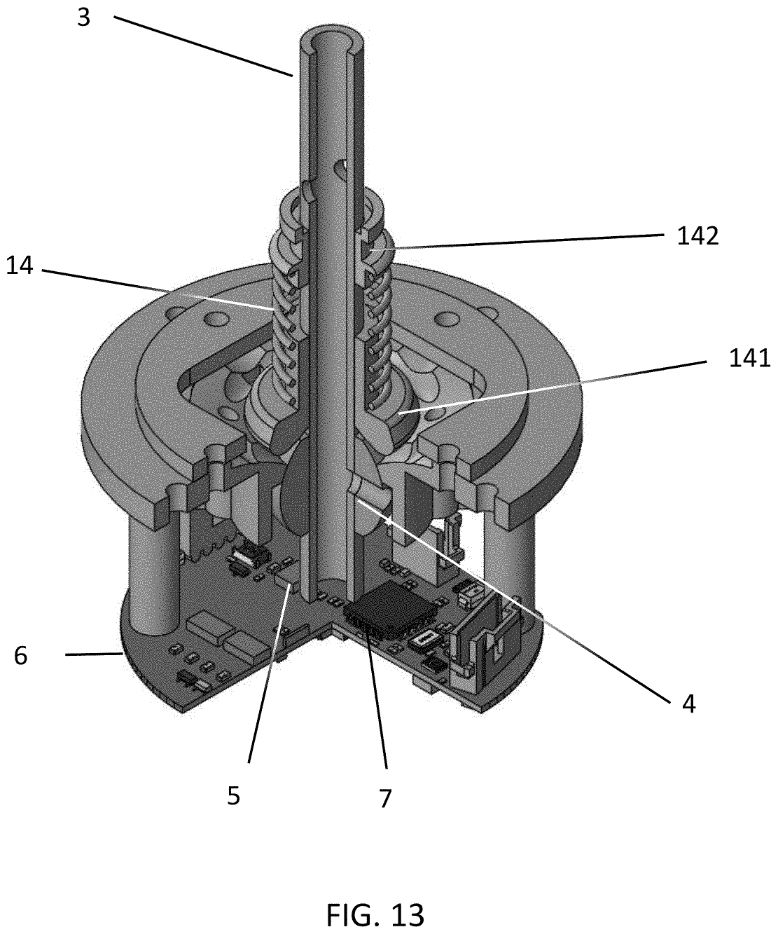

The embodiment of FIG. 13 shows an assembly of the mechanical members forming part of the base 1, in particular with reference to a spring mechanism 14 whose elastic characteristic is used to compensate the force of gravity and maintain the shaft in a vertical position when not stimulated, it is also possible to use the characteristic elastic force which, being directly proportional to the displacement, provides the operator using the joystick with the perception of the progressive displacement with respect to the rest position, since the return force increases as the offset between the rest position and the manually set position increases.

The concentric spring 14 surrounding the shaft 3 is held in position by the supports 141 and 142, which prevent it from moving towards the base 1 and the stick 2 of the joystick, respectively; the end of the shaft 3 opposite the stick 2 is coupled by means of one or more status sensors 5 to one or more electronic circuits 6, properly anchored to the supporting housing 41 and comprising one or more microprocessors 7 for processing the state, managing the commands and whatever is necessary for the functioning of the joystick management logic algorithm.

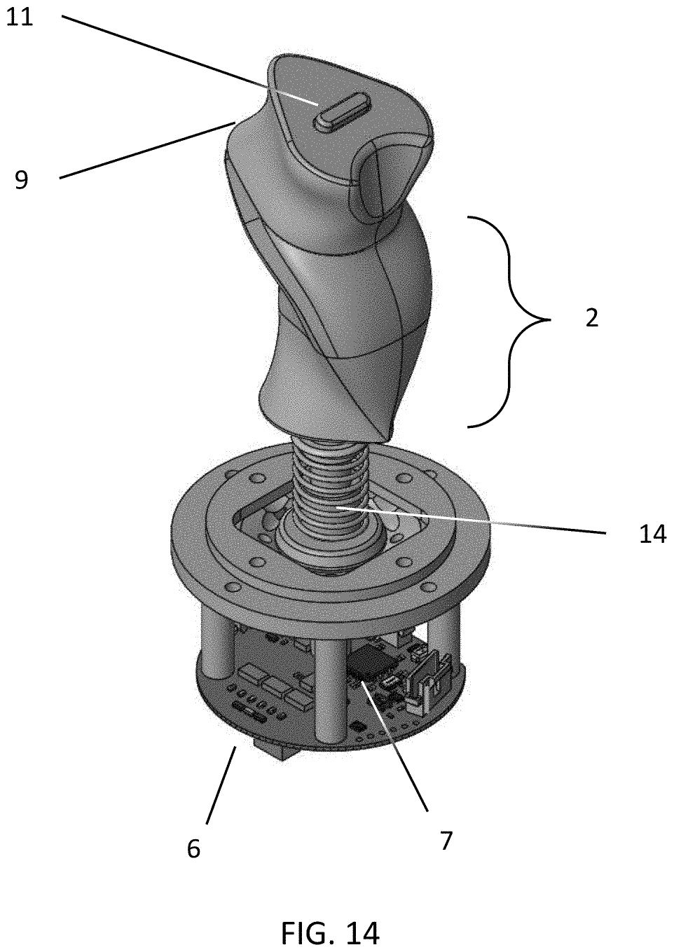

FIG. 14 shows a coupling between the members described above and the stick 2 of the joystick, said stick being connected to said members by means of an appropriate mechanical fastening on the shaft 3 and maintained in the rest position by the spring 14 as previously described; this embodiment comprises the presence of an operative member 9 arranged on the end of the stick, said operative member being able to sway around an axis possibly coinciding with the longitudinal axis of the shaft 3, and said operative member being provided with one or more auxiliary control buttons 11 possibly provided with a mechanism for maintaining the state of activation and/or light and/or tactile indication.

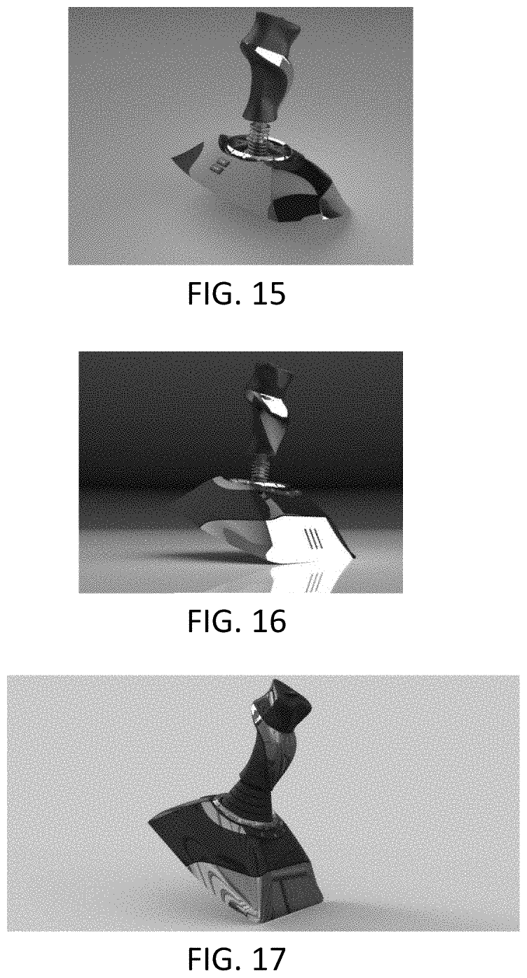

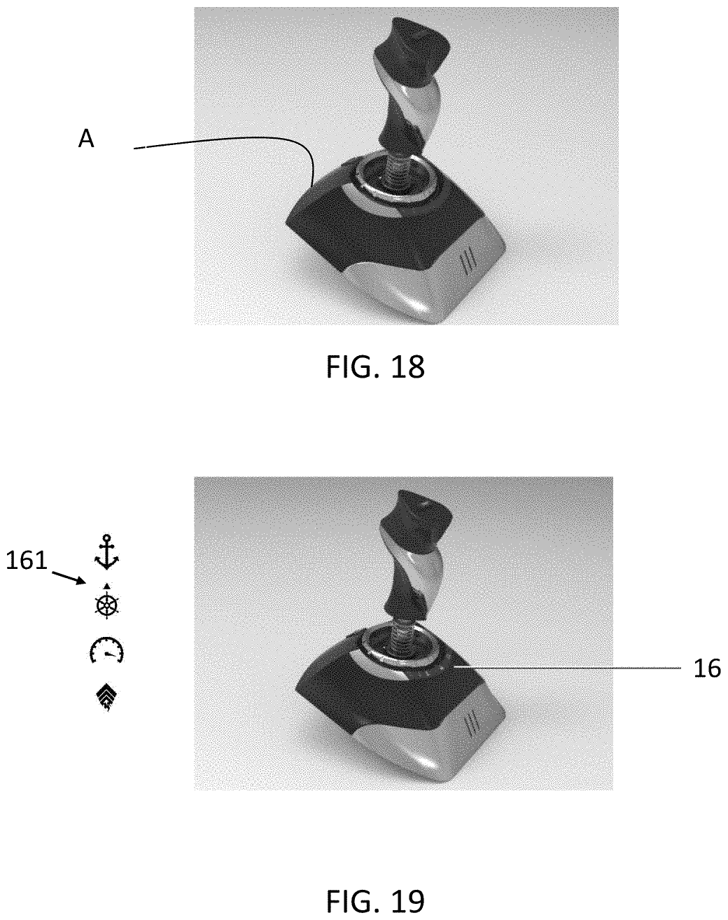

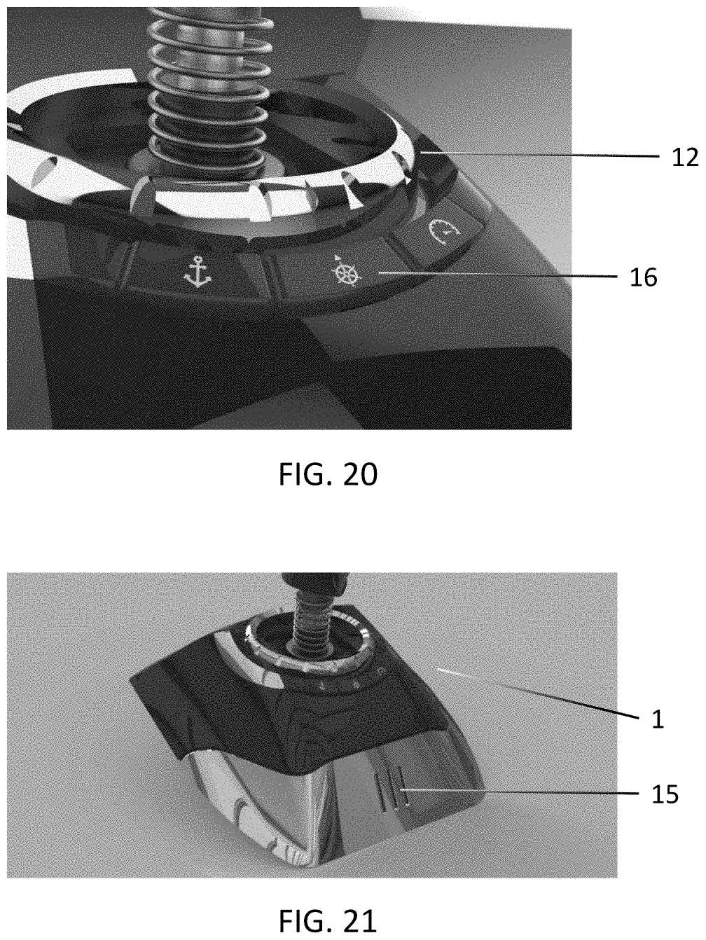

Other views of a possible embodiment are shown in FIGS. 15, 16, 17, 18 and 19; the embodiment of FIG. 19 further comprises an example of control buttons 16 as already shown in FIG. 4 and shown again in FIG. 20, which are positioned at the crown of the rotating ferrule and comprise graphic illustrations 161 for identifying the specific function that is recalled upon activation of said buttons.

FIG. 21 discloses a possible embodiment of the base 1 of the joystick comprising a system for generating acoustic and/or vocal signals 15, said signals being able to be generated by a transducer positioned within said base and said base being provided with appropriate slots allowing sound to propagate towards the operator.

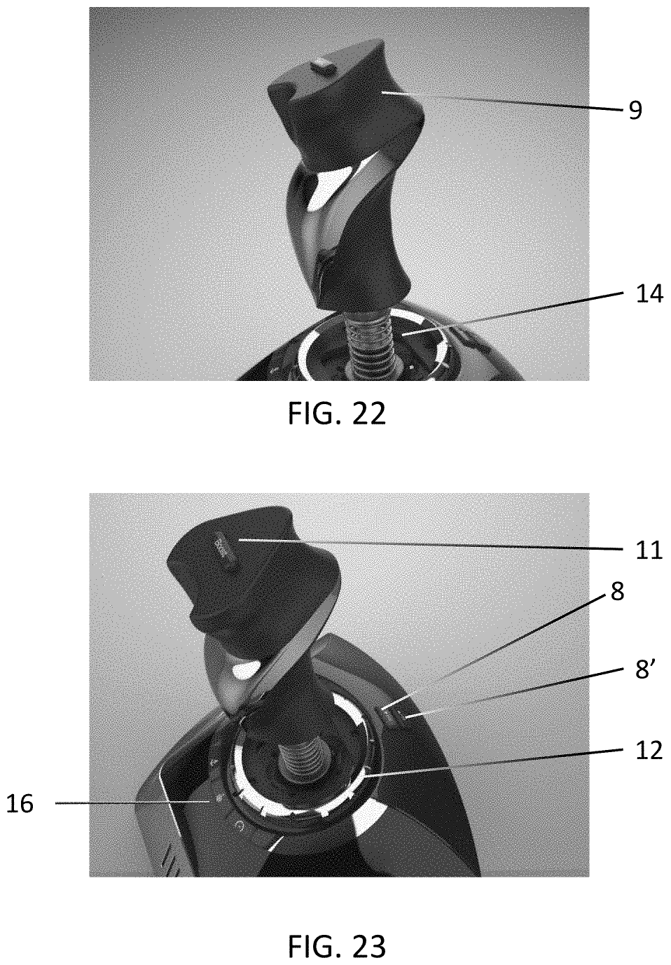

FIG. 22 further shows an embodiment of the stick with associated elastic spring member 14 for controlling the movement and swivel head 9 with thumb outline 91 and comprising an auxiliary control button 11, while the trim buttons 8, 8′, the ferrule-shaped rotatable ferrule 12 and the control buttons 16 with illustrations 161 can be seen in FIG. 23.

The invention claimed is:

1. A multi-axis articulated lever control member, configured as a joystick, for generating command signals aimed to control a movement of a boat by an operator, comprising:
a base;
a stick;
a shaft for supporting the stick;
a joint mechanically coupled to the shaft and contained in a supporting housing;
one or more status sensors;
one or more electronic circuits comprising at least one microprocessor; and
one or more control mechanisms configured as one or more buttons, a subset of the buttons being positioned on one or both of the stick or on the base of the lever control member, the buttons being usable by the operator for managing a swaying movement of at least one or more outboard motors around a horizontal axis parallel to a transom, the swaying movement being a trimming.

2. The multi-axis articulated lever control member according to claim 1, wherein the one or more status sensors are configured to detect information on a status of the shaft and of the joint, the joint being configured as a spherical member, the information comprising information on position with reference to at least two and up to five degrees of freedom,
the at least one microprocessors being electrically coupled to the one or more status sensors and configured to detect a status of the shaft and of the spherical member and a consequent transition between two or more possible operative statuses at predetermined time intervals,
the at least one microprocessors being adapted to generate the command signals aimed to control the movement of the boat,
the lever control member being adapted for manual activation.

3. The multi-axis articulated lever control member according to claim 1, wherein one, a subset, or a totality of the one or more buttons comprises a device adapted to maintain an activation or deactivation status set by the operator without subsequent mechanical actions for maintaining the activation or deactivation status, the buttons having an individual light, a common light, or an acoustic signal to indicate the activation status.

4. The multi-axis articulated lever control member according to claim 1, wherein the one or more control buttons are provided with an electric, mechanical, or electromechanical device adapted to determine a progressive pressure exerted by the operator, the electric, mechanical, or electromechanical device being electrically coupled to the one or more microprocessors for a modular and progressive management of an inclination of at least one of the one or more outboard motors.

5. The multi-axis articulated lever control member according to claim 1, wherein at least one of the one or more of the control mechanisms has a predetermined geometrical shape prearranged for use by the operator for setting various types of controls for managing movement or parking of the boat.

6. The multi-axis articulated lever control member according to claim 1, wherein at least one of the one or more of the control mechanisms is equipped with graphical or tactile symbols of various shapes and sizes, adapted to facilitate recognition and selection by the operator.

7. The multi-axis articulated lever control member according to claim 1, wherein the one or more motors are adapted to operate independently and are mechanically secured at a stern of with a mechanism that enables a positioning of the one or more motors along a longitudinal plane normal to the transom, the mechanism being driven by one or more actuators adapted to control the positioning of at least one of the one or more motors depending on the command signals processed by the one or more microprocessors based on one or more algorithms acting input signals coming from the buttons.

8. The multi-axis articulated lever control member according to claim 1, further comprising a system that generates acoustic signals with one or more electroacoustic transducers, a control action being differentiated according to a type of action by the operator, or to a configuration of the one or more electronic circuits.

9. The multi-axis articulated lever control member according to claim 1,
wherein an end part of the stick is equipped with an operative unit configured to carry out at least one sway when manually stimulated by the operator, the sway occurring independently of other possible movements carried out by the operator on the control member, and
wherein the operative unit comprises an ergonomic outline that facilitates use by the operator.

10. The multi-axis articulated lever control member according to claim 9, wherein the operative unit is provided with one or more control mechanisms electrically coupled to at least one of the one or more electronic circuits,
one, a subset, or a totality of the buttons having a device adapted to maintain an activation or deactivation status set by the operator, without successive mechanical actions for maintaining the status,
the buttons having an individual light, a common light, or an acoustic signal to indicate the activation status.

11. The multi-axis articulated lever control member according to claim 1, wherein one or more of the buttons are positioned on a surface of a casing of the stick or on a rotating head positioned at an end part of the stick so as to enable activation by the operator with an action of a thumb without interfering with other possible actuations of the control member.

12. The multi-axis articulated lever control member according to claim 1, further comprising a rotating body (that is manually positionable by the operator in one or more predefined positions, or in any status of a range of variable positions between a maximum and a minimum position when predefined positions are not provided,
the maximum and minimum positions not being limited a priori.

13. The multi-axis articulated lever control member according to claim 12, wherein the rotating body is equipped with a system of one or more status sensors electrically connected to the one or more microprocessors for processing signals generated in response to static or dynamic conditions following actuation by the operator.

14. The multi-axis articulated lever control member according to claim 12, wherein the rotating body comprises one or more light indicators adapted to signal, continuously or temporarily according to a predefined duration, a status of the rotating body.

15. The multi-axis articulated lever control member according to claim 1, wherein the stick has an at rest position when not stimulated by the operator, the at rest position being maintained by one or more mechanical members provided with biasing features so as to hold the shaft in a predetermined position without hampering a movement of the stick according to various degrees of freedom.

16. A multi-axis articulated lever control member, configured as a joystick, for generating command signals aimed to control a movement of a boat by an operator, comprising:
a base;
a stick;
a shaft for supporting the stick;
a sphere-shaped member mechanically coupled to the shaft and contained in a supporting housing;
one or more status sensors;
one or more electronic circuits comprising at least one microprocessor;
one or more control mechanisms configured as one or more buttons, a subset of the buttons being positioned on one or both of the stick or on the base of the lever control member; and
an operative unit positioned in an end part of the stick and configured, able to carry out at least one rotation, when manually stimulated by the operator, around a longitudinal axis of the shaft, the rotation occurring independently of movements carried out by the operator on the control member.

17. A multi-axis articulated lever control member, configured as a joystick, for generating command signals aimed to control a movement of a boat by an operator, comprising:
a base;
a stick;
a shaft for supporting the stick;
a sphere-shaped member mechanically coupled to the shaft and contained in a supporting housing;
one or more status sensors;
one or more electronic circuits comprising at least one microprocessor; and
a rotating body that is manually positionable by the operator in one or more predefined positions, or within a range of variable positions between a maximum and a minimum position when positions are not predefined,
the maximum and minimum positions not being limited a priori.

18. The multi-axis articulated lever control member according to claim 17, wherein the rotating body is arranged on a surface integral with the base of the control member and in-line with the shaft supporting the stick.

19. The multi-axis articulated lever control member according to claim 17, wherein the rotating body is shaped as a ferrule rotatable in one or two directions.
